(19) United States
(12) Patent Application Publication
(10) Pub. No.: US 2019/0272663 A1
(43) Pub. Date: Sep. 5, 2019

(54) SIMULATING DISPLAY OF A 2D DESIGN ON AN IMAGE OF A 3D OBJECT

(71) Applicant: Vida & Co., San Francisco, CA (US)

(72) Inventors: Avi Bar-Zeev, Oakland, CA (US); Cameron Preston, Oakland, CA (US); Umaimah Mendhro, Oakland, CA (US)

(21) Appl. No.: 16/293,469

(22) Filed: Mar. 5, 2019

Related U.S. Application Data
(60) Provisional application No. 62/638,462, filed on Mar. 5, 2018.

(51) Int. Cl. G06T 15/04; G06T 15/50

(52) U.S. Cl. CPC G06T 15/04; G06T 15/506

(57) ABSTRACT

Methods and systems are provided for real-time rendering of a simulated display of a 2D image on 3D object while retaining the object's original texture, folds, shadows, and lighting. The methods and systems give designers the ability to showcase their work in professional grade photography for fashion and lifestyle commerce without the cost and time invested in manually creating simulated displays of final products. The resultant images are fully customizable to the art of each individual design uploaded, giving the appearance of shadows, textures and folds in the underlying materials, as well as retaining hyper-real lighting and ambiance. Methods and systems and provided are described for displaying a 2D design to simulate its appearance on a 3D object, including using three image layers to simulate the display of a 2D design on an image of a 3D object.

### CROSS-REFERENCE TO RELATED APPLICATIONS

This application claims the benefit of U.S. Provisional Patent Application No. 62/638,462, filed Mar. 5, 2018, which is or are all hereby incorporated by reference in their entirety.

### FIELD OF THE INVENTION

The present invention relates to methods to simulate the display of a 2-dimensional (2D) design on a 3-dimensional (3D) object with contours, texture, folds, shadow, lighting, or highlights.

### BACKGROUND

On-demand production allows rapid experimentation, market feedback, and delivery of new products with the speed of real-time, without investing in inventory. Product designers can get instant feedback on product ideas, without ever creating the product or investing in inventory, allowing for less wasted time, material savings, and a higher return on investment through increased sales.

However, because the products are not yet manufactured, it may be difficult for designers and consumers to visualize what the final product may look like. Simulated images of not-yet-produced products may be generated by hand by an artist, but this process is time-consuming and expensive. Existing methods of automatically generating simulated images do not account for depth, shadows, and folds, resulting in artificial images that do not accurately portray the final product. While some existing methods allow simple recoloring of an object, they do not allow users to customize with user-designed textures. One approach is full 3D modeling of goods, but this approach is too computationally expensive to perform in real-time in a web browser.

### SUMMARY OF THE INVENTION

This disclosure describes systems and methods for real-time rendering of a simulated display of a 2D image on 3D object while retaining the object's original texture, folds, shadows, and lighting. The systems and methods described herein give designers the ability to showcase their work in professional grade photography for fashion and lifestyle commerce without the cost and time invested in manually creating simulated displays of final products. The resultant images are fully customizable to the art of each individual design uploaded, giving the appearance of shadows, textures and folds in the underlying materials, as well as retaining hyper-real lighting and ambiance.

Systems and methods are described for displaying a 2D design to simulate its appearance on a 3D object. Some embodiments described herein use three image layers to simulate the display of a 2D design on an image of a 3D object. The three layers may be a base image that shows a product, a mask image where one or more pixel values of the mask image represent at least one of folds, lighting, shadow, texture, or contours on the product, and a design image representing a 2d design. The pixels of the mask image are iterated over to calculate a luminance value of each pixel using a linear equation calculated on at least one of the red value, green value, and blue value of the mask image at the location of the pixel. Then, the luminance values are applied to the corresponding pixels of the design image to compute a final set of pixels representing a final image.

In some embodiments, the luminance values may be cubed and multiplied by a scaling factor. Input from a user in a web editor may be received to designate an x coordinate and y coordinate of the design image on the base image, and the x and y coordinates used to determine a correspondence between pixels of the design image and the mask image.

In some embodiments, the mask image may be applied to the design image as a mask so that pixels of the design image outside of the mask are not shown and pixels of the design image inside the mask are shown. In further embodiments, the luminance values may be multiplied by the corresponding pixels of the design image. In yet further embodiments, the luminance values may be multiplied by the corresponding pixels of the design image and adding the corresponding pixels of the base image. In still further embodiments, the luminance values may be multiplied by the corresponding pixels of the design image and adding the corresponding pixels of the base image.

Some embodiments relate to providing a highlight image representing the properties of a material of interest and positioning the highlight image on top of the final image, where the final image is at least partly visible through the highlight image.

One general aspect includes a method for displaying a 2D design to simulate its appearance on a 3D object, including providing a base image that shows a product, providing a design image representing a 2D design, providing an initial x coordinate and an initial y coordinate of the design image on the base image, processing the design image in vertical slices, and calculating a new y coordinate of each pixel in each vertical slice by using a geometric equation representing the contour of the product. Other embodiments of this aspect include corresponding computer systems, apparatus, and computer programs recorded on one or more computer storage devices, each configured to perform the actions of the methods.

In some embodiments, a mask image is provided where one or more pixel values of the mask image represent texture of the product and the pixels of the mask image are processed to calculate a luminance value of each pixel using a linear equation calculated on at least one of the red value, green value, and blue value of the mask image. Then, the luminance values are applied to the corresponding pixels of the design image to compute a final set of pixels representing a final image. Implementations of the described embodiments may include hardware, a method or process, or computer software on a computer-accessible medium.

### BRIEF DESCRIPTION OF THE DRAWINGS

FIG. 1 illustrates an exemplary network environment where some embodiments of the invention may operate.

FIG. 2 illustrates an exemplary method for simulating the display of a 2D design on an image of a 3D object by maintaining folds, lighting, shadow, texture, or contours of the 3D object after a 2D design is applied.

FIG. 3 illustrates an exemplary method for simulating the display of a 2D design on an image of a 3D object by maintaining folds, lighting, shadow, texture, or contours of the 3D object after a 2D design is applied.

FIG. 4 illustrates an exemplary method for simulating the display of a 2D design on an image of a 3D object by maintaining folds, lighting, shadow, texture, or contours of the 3D object after a 2D design is applied.

FIGS. 5A-C illustrate an example application of simulating the display of a 2D design on an image of a 3D object.

FIGS. 6A-B illustrate a close-up view of an example application of simulating the display of a 2D design on an image of a 3D object.

FIG. 7 illustrates an exemplary method for simulating the display of a 2D design on an image of a 3D object by performing a geometric manipulation of the 2D design to provide a 3D appearance.

FIGS. 8A-B illustrate an example application of simulating the display of a 2D design on an image of a 3D object using an image transform.

FIG. 9 illustrates an exemplary method for simulating the display of a 2D design on an image of a 3D object by showing highlights representing properties of a material.

FIGS. 10A-C illustrate an example application of simulating the display of a 2D design on an image of a 3D object using a highlight image.

FIGS. 11A-B illustrate an example application of simulating the display of a 2D design on an image of a 3D object using a highlight image.

FIG. 12 illustrates an exemplary method for simulating the display of a 2D design on an image of a 3D object.

FIGS. 13A-C illustrate example applications of simulating the display of a 2D design on an image of a 3D object.

FIGS. 14A-C illustrate examples of pattern effects which may be applied to design images prior to compositing, allowing creative variations of a single painting or photograph to be styled in multiple ways.

FIGS. 15A-B illustrate an example of a mirror effect that may be applied to design images.

FIGS. 16A-B illustrate an example graphical user interface that may be used in conjunction with the embodiments described in this disclosure.

FIGS. 16C-F illustrate various examples of products that may be selected by the graphical user interface. FIG. 2 illustrates an exemplary subset of growth metrics of a teacher.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Embodiments of the invention may comprise one or more computers. Embodiments of the invention may comprise software and/or hardware. Some embodiments of the invention may be software only and may reside on hardware. A computer may be special-purpose or general purpose. A computer or computer system includes without limitation electronic devices performing computations on a processor or CPU, personal computers, desktop computers, laptop computers, mobile devices, cellular phones, smart phones, PDAs, pagers, multi-processor-based devices, microprocessor-based devices, programmable consumer electronics, cloud computers, tablets, minicomputers, mainframe computers, server computers, microcontroller-based devices, DSP-based devices, embedded computers, wearable computers, electronic glasses, computerized watches, and the like. A computer or computer system further includes distributed systems, which are systems of multiple computers (of any of the aforementioned kinds) that interact with each other, possibly over a network. Distributed systems may include clusters, grids, shared memory systems, message passing systems, and so forth. Thus, embodiments of the invention may be practiced in distributed environments involving local and remote computer systems. In a distributed system, aspects of the invention may reside on multiple computer systems.

Embodiments of the invention may comprise computer-readable media having computer-executable instructions or data stored thereon. A computer-readable media is physical media that can be accessed by a computer. It may be non-transitory. Examples of computer-readable media include, but are not limited to, RAM, ROM, hard disks, flash memory, DVDs, CDs, magnetic tape, and floppy disks.

Computer-executable instructions comprise, for example, instructions which cause a computer to perform a function or group of functions. Some instructions may include data. Computer executable instructions may be binaries, object code, intermediate format instructions such as assembly language, source code, byte code, scripts, and the like. Instructions may be stored in memory, where they may be accessed by a processor. A computer program is software that comprises multiple computer executable instructions.

A database is a collection of data and/or computer hardware used to store a collection of data. It includes databases, networks of databases, and other kinds of file storage, such as file systems. No particular kind of database must be used. The term database encompasses many kinds of databases such as hierarchical databases, relational databases, post-relational databases, object databases, graph databases, flat files, spreadsheets, tables, trees, and any other kind of database, collection of data, or storage for a collection of data.

A network comprises one or more data links that enable the transport of electronic data. Networks can connect computer systems. The term network includes local area network (LAN), wide area network (WAN), telephone networks, wireless networks, intranets, the Internet, and combinations of networks.

In this patent, the term “transmit” includes indirect as well as direct transmission. A computer X may transmit a message to computer Y through a network pathway including computer Z. Similarly, the term “send” includes indirect as well as direct sending. A computer X may send a message to computer Y through a network pathway including computer Z. Furthermore, the term “receive” includes receiving indirectly (e.g., through another party) as well as directly. A computer X may receive a message from computer Y through a network pathway including computer Z.

Similarly, the terms “connected to” and “coupled to” include indirect connection and indirect coupling in addition to direct connection and direct coupling. These terms include connection or coupling through a network pathway where the network pathway includes multiple elements.

To perform an action “based on” certain data or to make a decision “based on” certain data does not preclude that the action or decision may also be based on additional data as well. For example, a computer performs an action or makes a decision “based on” X, when the computer takes into account X in its action or decision, but the action or decision can also be based on Y.

In this patent, “computer program” means one or more computer programs. A person having ordinary skill in the art would recognize that single programs could be rewritten as multiple computer programs. Also, in this patent, “computer programs” should be interpreted to also include a single computer program. A person having ordinary skill in the art would recognize that multiple computer programs could be rewritten as a single computer program.

The term computer includes one or more computers. The term computer system includes one or more computer systems. The term computer server includes one or more computer servers. The term computer-readable medium includes one or more computer-readable media. The term database includes one or more databases.

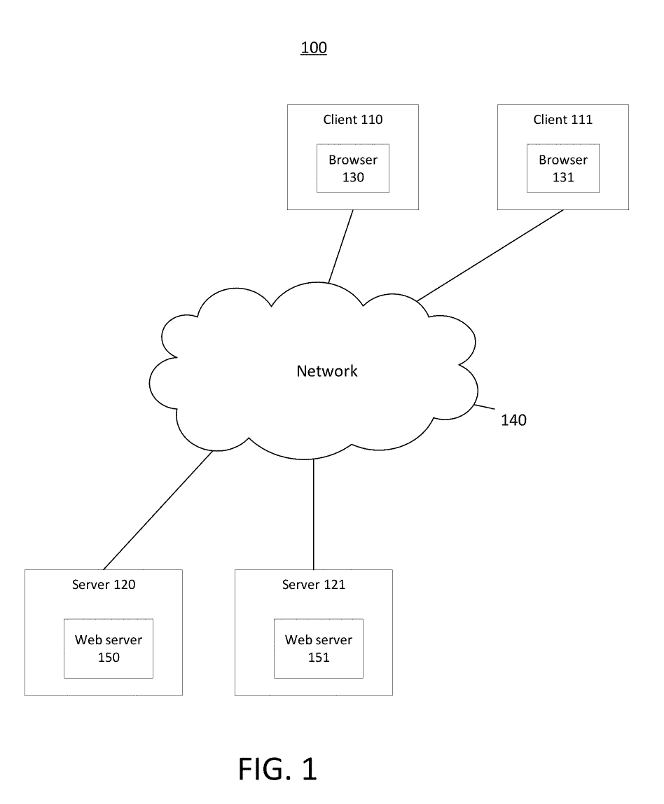

FIG. 1 illustrates an exemplary network environment 100 where some embodiments of the invention may operate. The network environment 100 may include multiple clients 110, 111 connected to one or more servers 120, 121 via a network 140. Network 140 may include a local area network (LAN), a wide area network (WAN), a telephone network, such as the Public Switched Telephone Network (PSTN), an intranet, the Internet, or a combination of networks. Two clients 110, 111 and two servers 120, 121 have been illustrated for simplicity, though in practice there may be more or fewer clients and servers. Clients and servers may be computer systems of any type. In some cases, clients may act as servers and servers may act as clients. Clients and servers may be implemented as a number of networked computer devices, though they are illustrated as a single entity. Clients may operate web browsers 130, 131, respectively for display web pages, websites, and other content on the World Wide Web (WWW). Servers may operate web servers 150, 151, respectively for serving content over the web.

Embodiments described herein use three image layers to simulate the display of a 2D design on an image of a 3D object. These three images are layered in succession to produce the final simulated image. The first layer may be referred to as the model layer or the base layer. This first layer includes an image of the 3D object and its surroundings. For example, the first layer may include a model wearing a garment and a background. In an example, the first layer may be an image of an object such as a pillow, a candle, a scarf, or other such objects in a studio setting. In some embodiments, the 3D object pictured in the first layer is pictured in a neutral tone such as a light gray.

The second layer may be referred to as the masking layer. The masking layer may include transparency, translucency, or opacity information in addition to image information. For example, a pixel of the masking layer may be fully transparent such that when the masking layer is composited on top of a background image, the background image is unchanged. In another example, a pixel of the masking layer image may be fully opaque such that it fully obscures a background pixel when composited over a background image. Yet other pixels of the masking layer image may be partially translucent such that the masking layer is blended with a background image when composited. The term opacity may refer to the opposite of translucency. That is, as opacity increases (i.e., tending toward fully opaque), translucency decreases. And as opacity decreases (i.e., tending toward fully transparent), translucency increases.

In an example, the masking layer image may be stored in a four-channel image format that includes an alpha channel in addition to color intensity information for each pixel of an image. In such image formats, three color channels describe the red, green, and blue color intensity of each pixel and an alpha channel describes the translucency or opacity of each pixel. In an embodiment, the Portable Network Graphics (PNG) image file format may be used to store a masking layer image that includes transparency information in an alpha channel. Other image file formats may be used such as the Tagged Image File Format (TIFF), the JPEG 2000 image file format, or any other image file format that supports alpha channel information. In some embodiments, an image file format that only supports binary transparency may be used. The image file formats only support fully transparent or fully opaque pixels. An example of such an image file format is the Graphics Interchange Format (GIF).

The masking layer image corresponds to the base layer image. For example, in an embodiment the masking layer includes fully transparent regions corresponding to the background in the base layer, and translucent regions corresponding to the 3D object in the base layer. In this embodiment, the translucent regions corresponding to the 3D object in the base layer include image information corresponding to features of the 3D object, such as textures, folds, shadows, lighting, and other such qualities.

The third image layer includes a design image or pattern to be applied to the 3D object and may be referred to as the design layer. The design layer may be, for example, a two-dimensional artistic design or photograph. The design layer may optionally include transparency or translucency information.

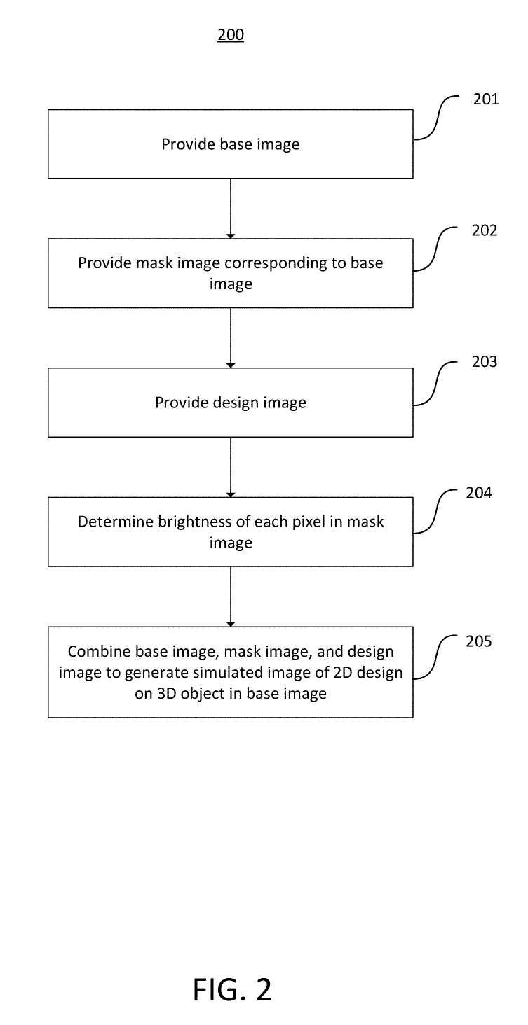

FIG. 2 illustrates an exemplary computer-implemented method 200 for simulating the display of a 2D design on an image of a 3D object by maintaining folds, lighting, shadow, texture, or contours of the 3D object after a 2D design is applied. At step 201, a base image is provided. The base image is a two-dimensional representation of a 3D object and a background. For example, the base image may be a photograph of a garment worn by a model standing in front of a wall. In some embodiments, the 3D object may be presented in the base image in a neutral tone such as a light gray or similar color.

At step 202, a mask image is provided that corresponds to the base image. In an embodiment, the mask image includes one or more pixel values that represent features of the 3D object such as folds, lighting, shadows, textures, or contours of the 3D object. In an embodiment, the mask image may be generated based on the base image using image editing software and stored in a database.

At step 203, a design image is provided. The design image is an artistic design that is to be applied to the 3D object. In an example, the design image may be a photograph or a 2D artistic image. In an embodiment, the design image is provided by a user.

At step 204, the brightness, or luminance, of each pixel of the mask image is determined. In other words, the color information of the mask image is discarded while the luminance information is retained. The brightness of each pixel of the mask image may be determined based on the color intensity information of the mask image. Each pixel of the mask image is processed to determine its corresponding luminance value while retaining the alpha channel, or translucency information of the mask image.

At step 205, the base image, the mask image, and the design image are combined to generate a simulated image of the 2D design of the design image applied to the 3D object pictured in the base image. The combination of these images which may include transparency information may be referred to as compositing or alpha-blending. The color information of the pixels of the design image is modulated by the luminance of the corresponding mask image as determined in the previous step. In other words, where the mask image is dark, the design image becomes darker too. For example, darker areas of the mask image may correspond to features of the underlying 3D object such as shadows, folds, textures, or the like. The alpha channel, or opacity information, of the mask image is then used to alpha-blend the mask image over the base image. In regions of the base image where the mask image contains transparent opacity values, the mask is then also transparent, and the base image is unmodified by the compositing. In regions of the base image where the mask image is highly opaque, the mask image fully overlaps the base image. In this way, the design image is alpha-blended on top of the base image only in regions allowed by the mask image, while also being modified to match the original lighting of the base image by the luminance values of the mask image. The end result is a composite simulated display of the 2D design on an image of a 3D object by maintaining folds, lighting, shadow, texture, or contours of the 3D object after the 2D design is applied.

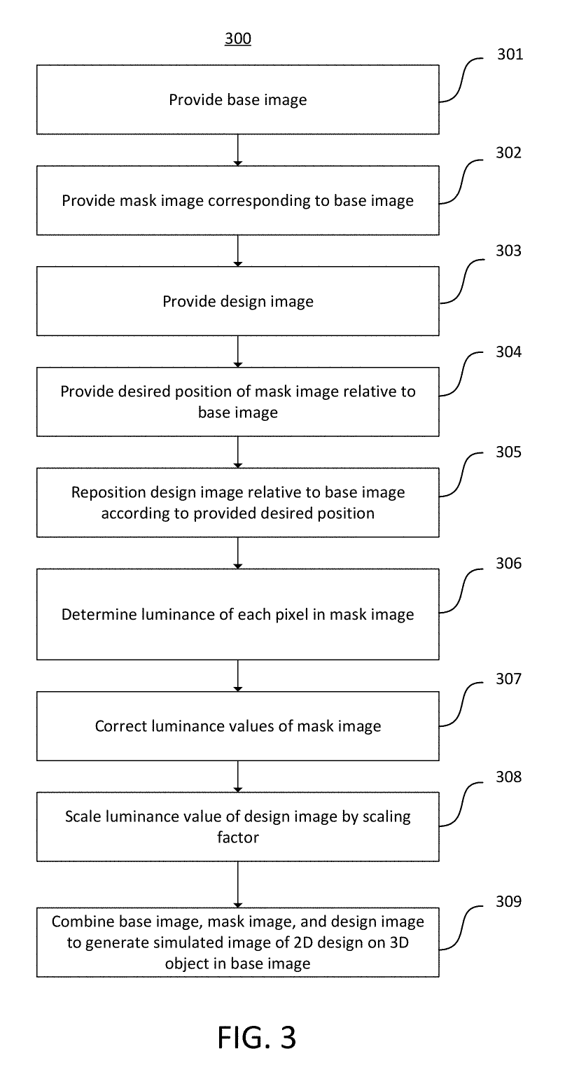

FIG. 3 illustrates an exemplary computer-implemented method 300 for simulating the display of a 2D design on an image of a 3D object by maintaining folds, lighting, shadow, texture, or contours of the 3D object after a 2D design is applied. Steps 301-303 are similar to steps 201-203 of method 200.

At step 301, a base image is provided. The base image is a two-dimensional representation of a 3D object and a background. For example, the base image may be a photograph of a garment worn by a model standing in front of a wall. In some embodiments, the 3D object may be presented in the base image in a neutral tone such as a light gray or similar color.

At step 302, a mask image is provided that corresponds to the base image. In an embodiment, the mask image includes one or more pixel values that represent features of the 3D object such as folds, lighting, shadows, textures, or contours of the 3D object. In an embodiment, the mask image may be generated based on the base image using image editing software and stored in a database.

At step 303, a design image is provided. The design image is an artistic design that is to be applied to the 3D object. In an example, the design image may be a photograph or a 2D artistic image. In an embodiment, the design image is provided by a user.

At step 304, a desired position of the mask image relative to the base image is provided. The position of the design image may be designated as an X and Y coordinate in the base image coordinate system. In an embodiment, a user may use a graphical user interface and input device such as a mouse to designate a position of the design image. In some embodiments, the graphical user interface may comprise a web editor running in a web browser.

At step 305, the design image may be repositioned relative to the base image according to the desired position provided in the previous step. In an example, the relative position of the design image may be adjusted to place a desired portion of the artistic design on top of the 3D object in the base image.

At step 306, the brightness, or luminance, of each pixel of the mask image is determined. In other words, the color information of the mask image is discarded while the luminance information is retained. The brightness of each pixel of the mask image may be determined based on the color intensity information of the mask image. In an example, the intensities of each color channel may be combined according to weights corresponding to the human visual perception of brightness for each color. In an embodiment, the red intensity value of a pixel is multiplied by a first weight, the green intensity value of the pixel is multiplied by a second weight, and the blue intensity value of the pixel is multiplied by a third weight. The, the weighted red value, weighted green value, and weighted blue value are summed to determine the relative luminance value for the pixel. For example, for images using the sRGB color space, the relative luminance of a pixel is calculated with the following formula:

V=0.2126×R+0.7152×G+0.0722×B

Where V is the relative luminance of the pixel, R is the red intensity of the pixel, G is the green intensity of the pixel, and B is the blue intensity of the pixel in the sRGB color space. Other color spaces and perceptive models may utilize different weights or techniques of determining the relative luminance based on color intensity information. Each pixel of the mask image is processed to determine its corresponding luminance value while retaining the alpha channel, or translucency information of the mask image.

At step 307, the luminance values of the mask image may be corrected according to a gamma correction operation. In an embodiment, the gamma correction function may be implemented by the following mathematical formula:

V′=Vt

Where V′ is the gamma-corrected relative luminance of a pixel, Y is the relative luminance of the pixel before gamma correction, G is a gamma value. The gamma value may be selected to enhance the folds, lighting, shadows, textures, or contours of the 3D object that are described by the luminance values of the design mask. A gamma value above unity will decrease the relative difference between darker values of luminance in the mask image and increase the relative difference between lighter values of luminance in the mask image. For example, in an embodiment, a gamma value of three may be selected to accentuate the lightest portions of the mask image.

At step 308, the gamma-adjusted luminance values of the design image may be scaled by a scaling factor. The scaling factor uniformly and linearly increases or decreases the luminance values of all pixels of the mask image. The entire gamma correction function including scaling may be implemented by the following mathematical formula:

V′=S×Vγ

Where V′ is the gamma-corrected relative luminance of a pixel, V is the relative luminance of the pixel before gamma correction, γ is a gamma value, and S is a scaling factor. A scaling factor below unity will decrease the overall brightness of the gamma-corrected mask image while a scaling factor above unity will increase the overall brightness of the gamma-corrected mask image. Selection of the gamma value and scaling factor may be adjusted based on the content of the mask image, the base image, and the design image.

At step 309, the base image, the mask image, and the design image are combined to generate a simulated image of the 2D design of the design image applied to the 3D object pictured in the base image. The combination of these images which may include transparency information may be referred to as compositing or alpha-blending. The color information of the pixels of the design image is modulated by the luminance of the corresponding mask image as determined in the previous step. In other words, where the mask image is dark, the design image becomes darker too. In an embodiment, the compositing of the base image, the mask image, and the design image may be described by the following set of formulas:

R=(DR×V′)×α+BR×(1−α)

G=(DG×V′)×α+BG×(1−α)

B=(DB×V′)×α+BB×(1−α)

Where R, G, and B represent the red, green, and blue color values of a pixel of the final image; DR, DG, and DB represent the color values of the corresponding design image pixel; V′ represents the gamma-corrected luminance value of the corresponding mask image pixel; α represents the transparency information of the corresponding mask image pixel; and BR, BG, and BB represent the color values of the corresponding background image pixel. In this way, the design image is alpha-blended on top of the base image only in regions allowed by the mask image, while also being modified to match the original lighting of the base image by the luminance values of the mask image. The result is a composite simulated display of the 2D design on an image of a 3D object by maintaining folds, lighting, shadow, texture, or contours of the 3D object after the 2D design is applied.

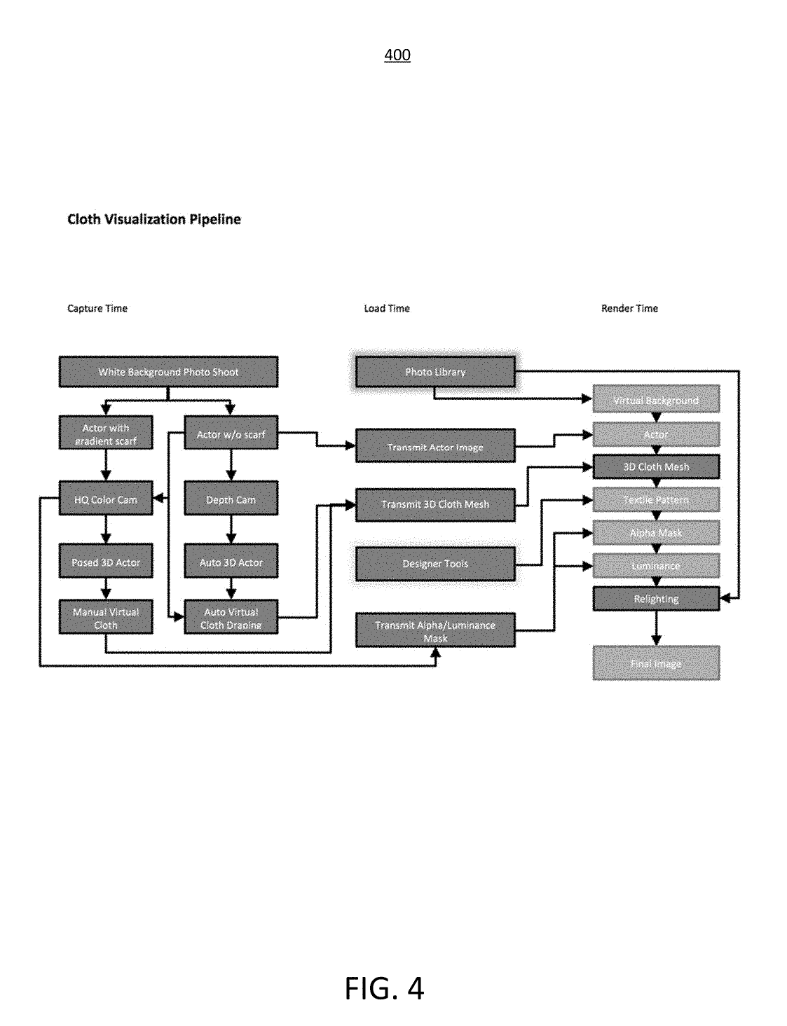

FIG. 4 illustrates an exemplary computer-implemented method 400 for simulating the display of a 2D design on an image of a 3D object by maintaining folds, lighting, shadow, texture, or contours of the 3D object after a 2D design is applied. Method 400 is similar to method 300, but in method 400, the alpha mask, textile pattern, and luminance information of the mask image are provided in three separate images. The disaggregation of these three components of the mask image of method 300 provide for additional flexibility in implementation.

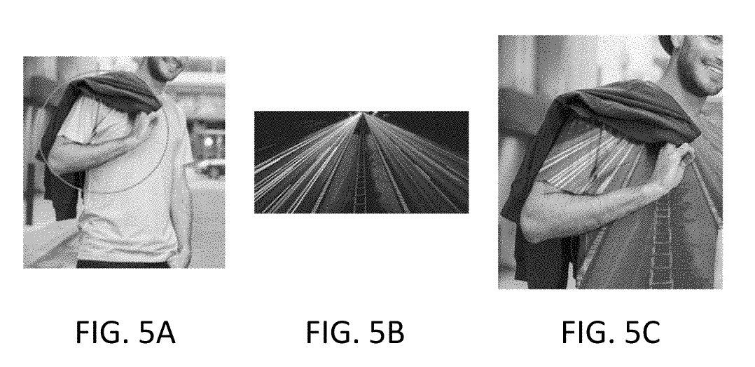

FIGS. 5A-C illustrate an example application of simulating the display of a 2D design on an image of a 3D object. FIG. 5A is an example base image showing a two-dimensional representation of a 3D object and a background. In FIG. 5A, the 3D object is the shirt the model is wearing. The remaining portions of FIG. 5A that other than the shirt are the background portions of the base image. In FIG. 5A, the shirt is photographed in a neutral tone to facilitate compositing. FIG. 5B is an example design image that is to be applied to the base image illustrated in FIG. 5A. Here, the design image of FIG. 5B is a 2D artistic design. FIG. 5C illustrates the result of applying the design image of FIG. 5B onto the base image of FIG. 5A using the methods described herein. In FIG. 5C, the design image of FIG. 5B has been composited on top of the base image of FIG. 5A while retaining the lighting, shadows, textures, and folds of the shirt as pictured in FIG. 5A. The folds and shadows of the fabric show through the design image layer, as if the model were actually wearing a shirt printed with the design image. Furthermore, the design image is applied only to the shirt, not the model's arm and the background portions of the base image. The result is a dynamically-created hyper-real product image that shows what the shirt pictured in FIG. 5A would look like if printed with the design of FIG. 5B.

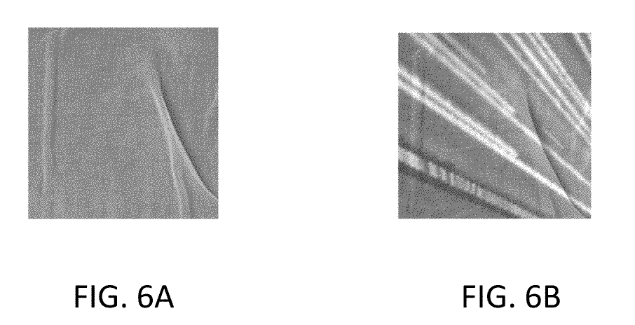

FIGS. 6A-B illustrate a close-up view of an example application of simulating the display of a 2D design on an image of a 3D object. FIG. 6A is a close-up view of a mask image that shows in detail the lighting, textures, and folds of a piece of cloth such as a garment. In other examples, the material may be fabric, glass, metal, wood, cotton, silk, wood, wax, leather, glass, gold, silver, precious stones, or other such materials. FIG. 6B illustrates a resultant simulated display of a design on the cloth illustrated in FIG. 6A produced by the methods described herein. In FIG. 6B, the textures and folds of the cloth as pictured in FIG. 6A are retained while the applied design has been composited over the original base image. The result in FIG. 6B illustrates the hyper-real product imagery that is made possible by embodiments described herein.

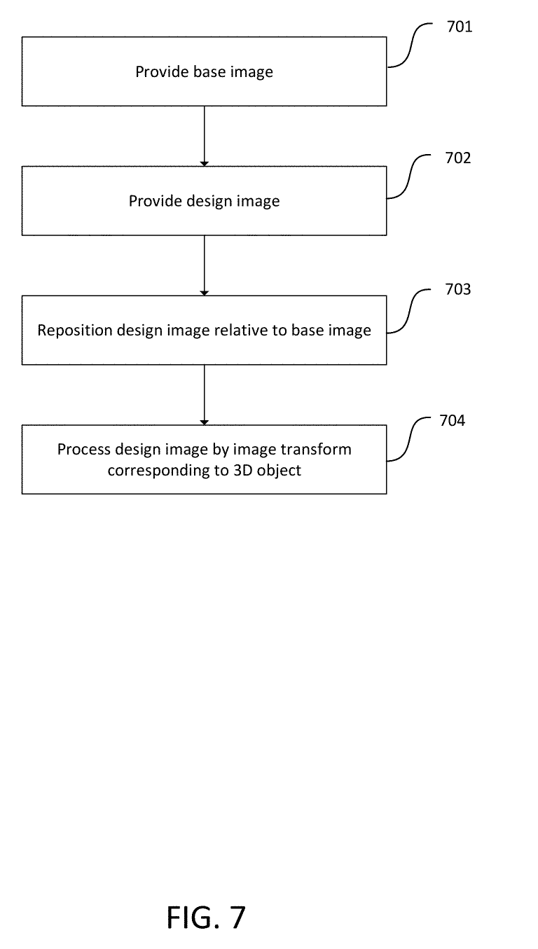

FIG. 7 illustrates an exemplary computer-implemented method 700 for simulating the display of a 2D design on an image of a 3D object by performing a geometric manipulation of the 2D design to provide a 3D appearance.

At step 701, a base image is provided. The base image is a two-dimensional representation of a 3D object and a background. For example, the base image may be a photograph of a 3D object such as a candle. In some embodiments, the 3D object may be presented in the base image in a neutral tone such as a light gray or similar color.

At step 702, a design image is provided. The design image is an artistic design that is to be applied to the 3D object. In an example, the design image may be a photograph or a 2D artistic image. In an embodiment, the design image is provided by a user.

At step 703, the design image may be repositioned relative to the base image. The position of the design image may be designated as an X and Y coordinate in the base image coordinate system. In an example, the relative position of the design image may be adjusted to place a desired portion of the artistic design on top of the 3D object in the base image. In an embodiment, a user may use a graphical user interface and input device such as a mouse to designate a position of the design image. In some embodiments, the graphical user interface may comprise a web editor running in a web browser.

At step 704, the design image is processed by an image transform corresponding to the 3D object. In general, the design image transform maps each pixel of the design image to new coordinates. In an example, the design image transform may correspond to the geometry of the 3D object pictured in the base image. For example, an image transform may be an equation representing the geometry of a 3D object such as a candle. Because the candle in this example is an ellipse, an image transform corresponding to the candle may be based on the geometric properties of an ellipse. In this example, then, the pixel coordinates of the design image are transformed through an equation representing the geometry of an ellipse to determine new pixel coordinates. In some examples, only one coordinate is modified, and the other coordinate is unmodified. In the candle example, because the candle is a cylinder that does not have geometry in the Y axis, only the Y coordinate is transformed. In this example, the image may be processed in vertical slices along the X axis, with each Y coordinate being determined by a geometric equation describing the contour of the candle. An exemplary image transform that may be applied to compute the Y coordinates to simulate display of a 2D design on the candle, using the equation for an ellipse is:

$$Y = \frac{b}{a} * \sqrt{a * a - ( X - a ) * ( X - a )}$$

Where a represents the ellipse width and b represents the roundness of the ellipse.

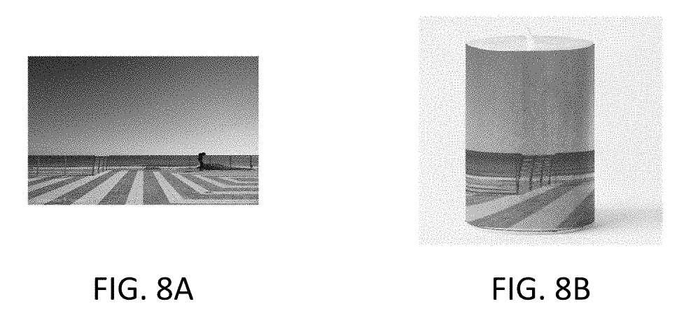

FIGS. 8A-B illustrate an example application of simulating the display of a 2D design on an image of a 3D object using an image transform. FIG. 8A illustrates a flat, 2D design image. FIG. 8B illustrates a simulated display of a candle with the 2D design of FIG. 8A applied to it. In this example, the geometry of the flat design image has been modified through an image transform related to the geometry of the candle to create a more realistic image.

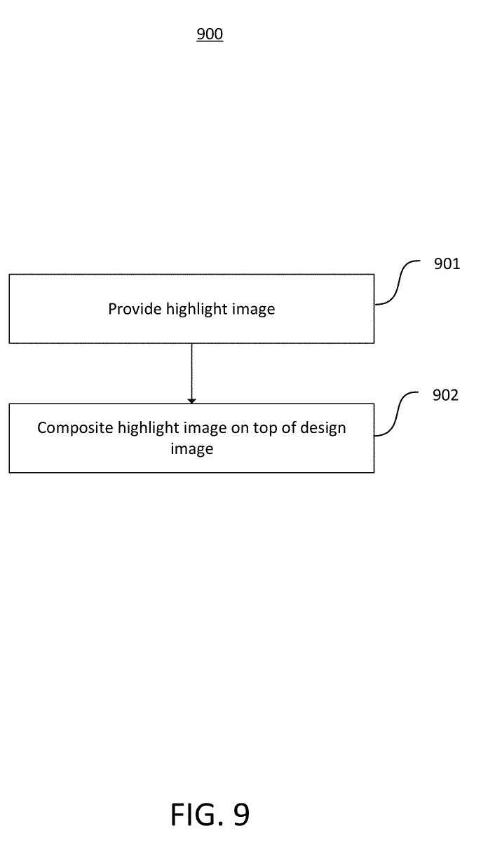

FIG. 9 illustrates an exemplary computer-implemented method 900 for simulating the display of a 2D design on an image of a 3D object by showing highlights representing properties of a material. At step 901, a highlight image representing the properties of a material is provided. The highlight image is similar to a mask image in that it may comprise an image including an alpha channel to describe translucency. In embodiments, the highlight image may comprise low alpha channel values such that the highlight image is highly translucent. The highlight image may also include chrominance information in red, green, and blue pixel intensity values. The highlight image may correspond to a 3D object in a base image and artistically designed to highlight certain attributes of the 3D object. For example, the highlight image may give the appearance of certain materials such as glass, metal, plastic, or other such materials.

In step 902, the highlight image is composited on top of a design image to produce a highlighted design image. The resultant highlighted design image may be used in place of a design image in any of the embodiments described herein. The process of compositing the highlight image on top of the design image is analogous to the process of compositing a mask image on top of a design image as described in connection with the embodiments described herein. However, rather than retain only luminance information as with the mask image, the chrominance information of the highlight image is retained and alpha-blended with the design image. In this way, the highlight image may add color information to the design image to further enhance the simulation of applying a 2D design to a 3D object. The compositing of the highlight image over the design image may be described by the following set of equations:

R=HR×Hα+DR×(1−Hα)

G=HG×Hα+DG×(1−Hα)

B=HB×Hα+DB×(1−Hα)

Where R, G, and B represent the red, green, and blue color values of a pixel of the highlighted design image; HR, HG, and HB represent the color values of the corresponding highlight image pixel; Ha represents the transparency information of the highlight image pixel; and DR, DG, and DB represent the color values of the corresponding design image pixel.

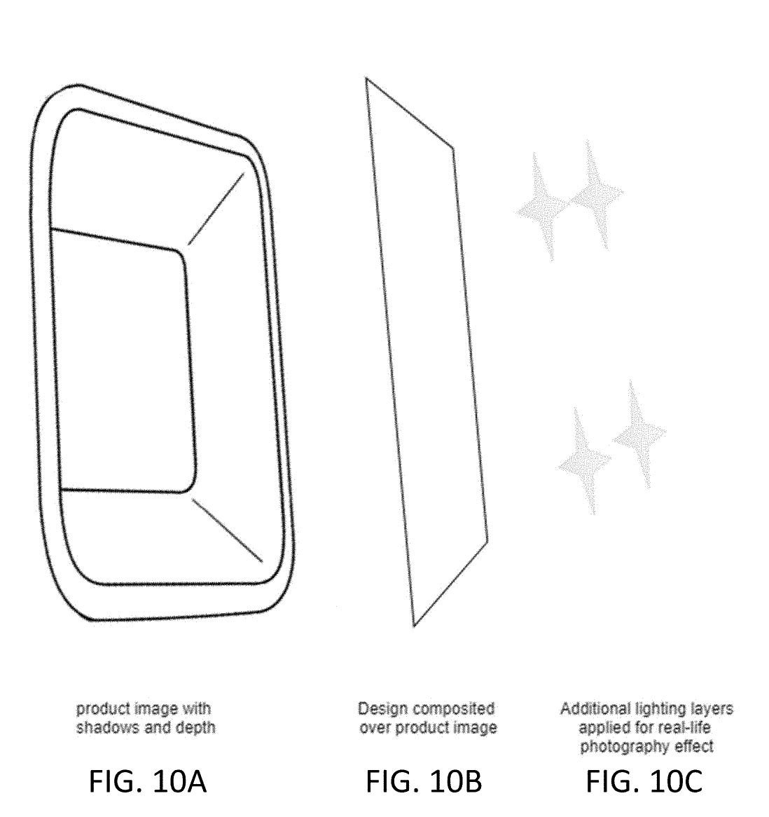

FIGS. 10A-C illustrate an example application of simulating the display of a 2D design on an image of a 3D object using a highlight image. FIG. 10A illustrates a base image showing a 3D object with shadows and depth. In this example, the 3D object is a product made of a glass material. FIG. 10B illustrates a 2D design image that is to be composited over the base image illustrated in FIG. 10A to simulate the display of the design on the product. FIG. 10C illustrates an example highlight image comprising chrominance image data to be composited over the design image to enhance the simulated display of the design on the product.

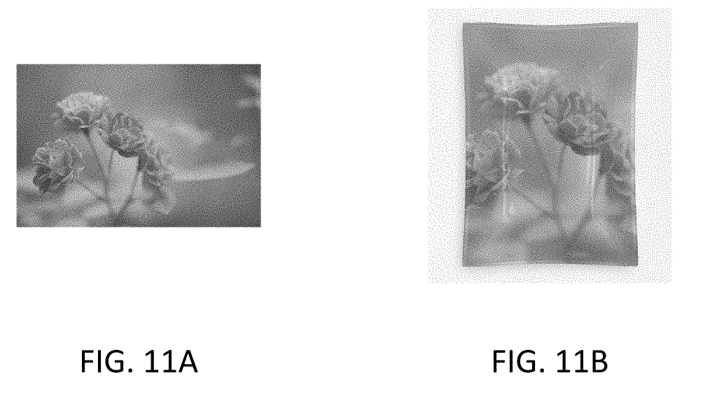

FIGS. 11A-B illustrate an example application of simulating the display of a 2D design on an image of a 3D object using a highlight image. FIG. 11A is a flat, 2D design image. This design image depicts a photograph of a flower. FIG. 11B illustrates a simulated display of the design of FIG. 11A as applied to an image of a glass bowl 3D object using a highlight image which highlights the unique aspects of the material. This gives the resulting simulated image a highly refined touch while still supporting instant product image creation by users, without specialized training or hours or days of manual work.

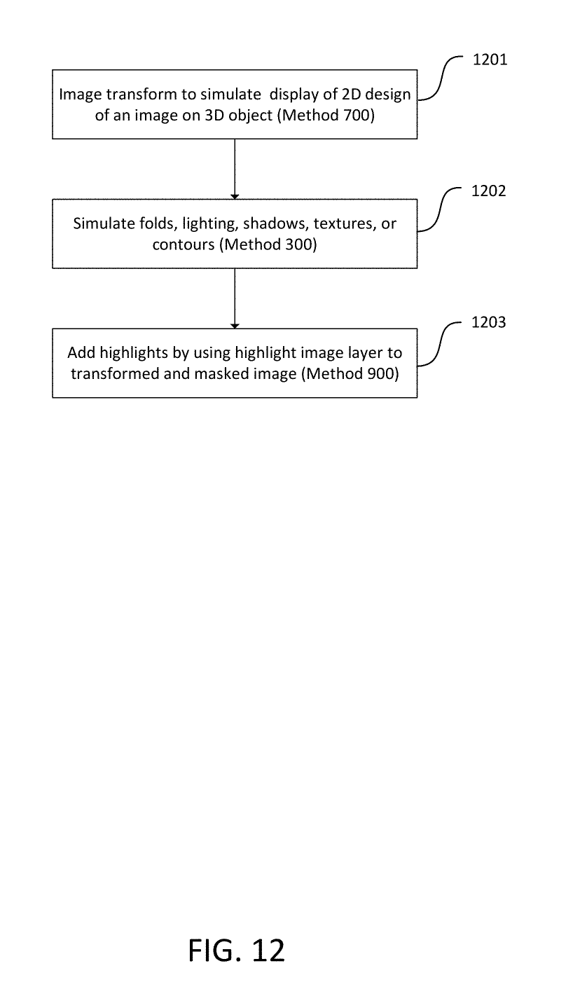

FIG. 12 illustrates an exemplary computer-implemented method 1200 for simulating the display of a 2D design on an image of a 3D object. Methods described in this disclosure may be combined to produce a desired simulated display. For example, at step 1201, method 700 may be performed to simulate the display of a 2D design of an image of a 3D object by performing an image transform of a design image. Then, at step 1202, method 300 may be performed to simulate folds, lighting, shadows, textures, or contours of the 3D object using a masking image layer composited on top of the transformed design image. Finally, at step 1203, method 900 may be performed on the transformed and masked image to add highlights by using a highlight image layer. In this way the various techniques and methods of this disclosure may work together to produce a final simulated display of a 2D design on an image of a 3D object.

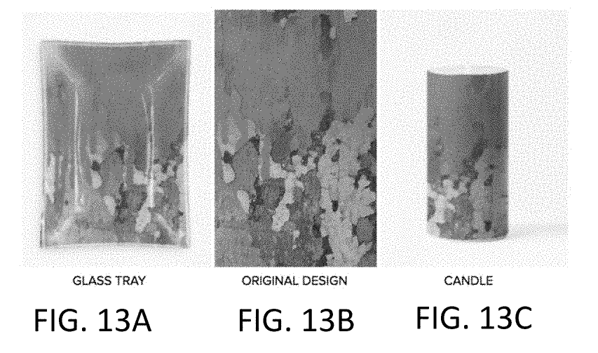

FIGS. 13A-C illustrate example applications of simulating the display of a 2D design on an image of a 3D object according to embodiments described herein. In FIGS. 13A-C, the same original design image is applied to two different products using various techniques described herein. FIG. 13B shows an original artistic 2D design image as provided by a user. FIG. 13A illustrates the design image of FIG. 13B applied to a glass tray product using a highlight image to accentuate the characteristics of the glass material. FIG. 13C illustrates the same design image of FIG. 13B applied to a candle product using an image transform to warp the design image such that it convincingly looks like the design image has been applied to the real-life candle. These examples and others below illustrate the flexibility the disclosed embodiments provide in the creation of professional-looking editorial photography, providing designers with powerful tools to create their own professional photos without the need to work with fashion photographers and models. These examples and others illustrate finished-looking, hyperreal products with beautiful editorial fashion photography, without ever creating the product.

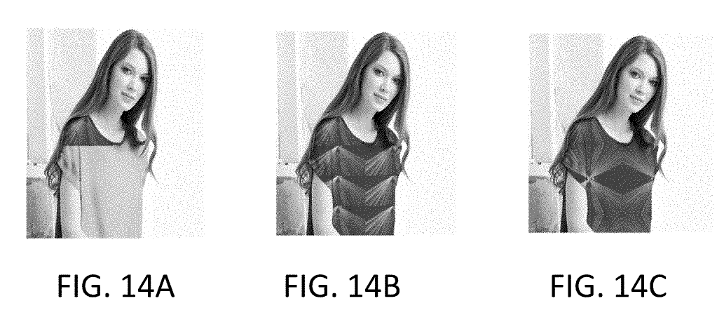

FIGS. 14A-C illustrate examples of pattern effects which may be applied to design images prior to compositing, allowing creative variations of a single painting or photograph to be styled in multiple ways. FIG. 14A illustrates an example of placing a design image such that it only covers a portion of the 3D object pictured in the base image. For example, in FIG. 14A, the design is only applied to the uppermost portion of the shirt product while the rest of the shirt is left blank. FIG. 14B illustrates a patterning effect where an input design image may be scaled down and repeated or tiled to fill up the surface area of the 3D object pictured in the base image. FIG. 14C illustrates a mirror effect where an input design image may be scaled down and flipped horizontally and vertically to create a seamless pattern-like effect based on a single input design image. Some embodiments allow that a user may position a design image on a base image to establish the location of the design image on the base image. This may occur by providing tools in a web editor, an editor in a web browser, that allows repositioning images. Compressed images may be used to allow for fast rendering in a web browser. Meanwhile, higher resolution images may be stored for printing the design image on real life objects that users purchase from a website based on the composite images. In the printing process, filters may be applied in real-time to a design to allow for modification of a design during printing. Methods herein simulate display of 2D designs on images of 3D objects very quickly and may be performed in real-time in a web browser. As a user manipulates the location of a 2D design that is overlaid on top of a base image of a 3D object, the display may be updated in real-time to photorealistically simulate the appearance of the 2D design on the 3D object at the location designated by the user.

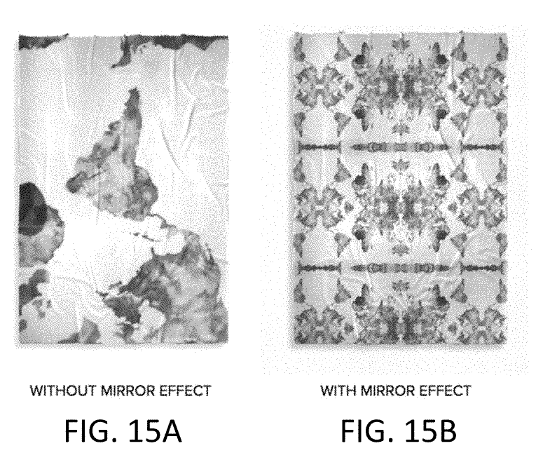

FIGS. 15A-B illustrate an example of a mirror effect that may be applied to design images. The mirror effect flips the imagery vertically and horizontally, creating a sophisticated kaleidoscope-like pattern based on a single design image input. For example, FIG. 15A illustrates a simulated display of a particular design image on a cloth. FIG. 15B illustrates an example of the same design of FIG. 15A but scaled down in size and repeated in a mirror effect to cover the entire cloth. In this way, a user may create novel patterns and designs while visualizing what those patterns and designs may look like on a product with hyper-real imagery.

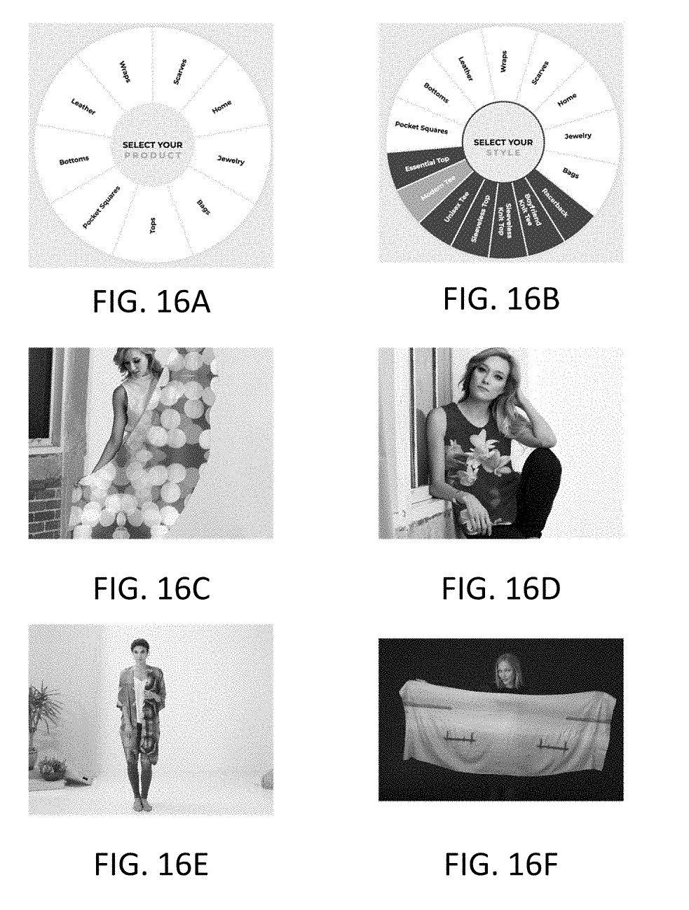

FIGS. 16A-B illustrate an example graphical user interface that may be used in conjunction with the embodiments described in this disclosure. FIG. 16A illustrates a product selection graphical user interface that displays available product categories in a wheel presentation. Clicking on one of the categories presented causes the graphical user interface to expand that piece of the wheel to display sub-categories. For example, FIG. 16B illustrates the sub-category selection after the “Tops” category was selected by a user in FIG. 16A. A user may then proceed to select a sub-category such as a “Modern Top” as illustrated in FIG. 16B. In some embodiments, the graphical user interfaces of FIGS. 16A-B are presented in a web browser such as web browsers 130, 131. In these embodiments, the method for simulating the display of a 2D design on an image of a 3D object is also executed in the web browser of an end user. In some embodiments, the method for simulating the display of a 2D design on an image of a 3D object utilizes various features of web browsers 130, 131 to implement the image manipulation steps described herein. For example, methods may use the HTML5 Canvas element and Javascript code, or other browser scripting code, to implement the image manipulation steps.

FIGS. 16C-F illustrate various examples of products that may be selected by the graphical user interface of FIGS. 16A-B and processed according to various embodiments described herein. For example, FIG. 16C illustrates a simulated display of a 2D design on an image of a scarf product. FIG. 16D illustrates a simulated display of a 2D design on an image of a shirt product. FIG. 16E illustrates a simulated display of a 2D design on an image of a wrap product. FIG. 16F illustrates an alternate simulated display of a 2D design on an image of a scarf product. Each of FIGS. 16C-F are examples of image that may be produced according to methods described herein.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed:

1. A method for displaying a 2D design to simulate its appearance on a 3D object, the method comprising:
providing a base image that shows a product;
providing a mask image where one or more pixel values of the mask image represent at least one of folds, lighting, shadow, texture, or contours on the product;
providing a design image representing a 2D design;
iterating over the pixels of the mask image to calculate a luminance value of each pixel using a linear equation calculated on at least one of the red value, green value, and blue value of the mask image at the location of the pixel;
applying the luminance values to the corresponding pixels of the design image to compute a final set of pixels representing a final image.

2. The method of claim 1, further comprising:
cubing the luminance values;
multiplying the luminance values by a scaling factor.

3. The method of claim 1, further comprising:
receiving input from a user in a web editor to designate an X coordinate and Y coordinate of the design image on the base image;
using the X coordinate and Y coordinate to determine a correspondence between pixels of the design image and the mask image.

4. The method of claim 1, further comprising:
applying the mask image to the design image as a mask so that pixels of the design image outside of the mask are not shown and pixels of the design image inside the mask are shown.

5. The method of claim 1, further comprising:
multiplying the luminance values by the corresponding pixels of the design image.

6. The method of claim 1, further comprising:
multiplying the luminance values by the corresponding pixels of the design image and adding the corresponding pixels of the base image.

7. The method of claim 1, further comprising:
multiplying the luminance values by the corresponding pixels of the design image and adding the corresponding pixels of the base image.

8. The method of claim 1, further comprising:
providing a highlight image representing the properties of a material of interest;
positioning the highlight image on top of the final image, where the final image is at least partly visible through the highlight image.

9. A method for displaying a 2D design to simulate its appearance on a 3D object, the method comprising:
providing a base image that shows a product;
providing a design image representing a 2D design;
providing an initial X coordinate and an initial Y coordinate of the design image on the base image;
processing the design image in vertical slices and calculating a new Y coordinate of each pixel in each vertical slice by using a geometric equation representing the contour of the product.

10. The method of claim 9, further comprising:
providing a mask image where one or more pixel values of the mask image represent texture of the product;
iterating over the pixels of the mask image to calculate a luminance value of each pixel using a linear equation calculated on at least one of the red value, green value, and blue value of the mask image;
applying the luminance values to the corresponding pixels of the design image to compute a final set of pixels representing a final image.

11. A non-transitory computer-readable medium comprising instructions for displaying a 2D design to simulate its appearance on a 3D object, the non-transitory computer-readable medium comprising instructions for:
providing a base image that shows a product;
providing a mask image where one or more pixel values of the mask image represent at least one of folds, lighting, shadow, texture, or contours on the product;
providing a design image representing a 2D design;
iterating over the pixels of the mask image to calculate a luminance value of each pixel using a linear equation calculated on at least one of the red value, green value, and blue value of the mask image at the location of the pixel;
applying the luminance values to the corresponding pixels of the design image to compute a final set of pixels representing a final image.

12. The non-transitory computer-readable medium of claim 11, further comprising instructions for:
cubing the luminance values;
multiplying the luminance values by a scaling factor.

13. The non-transitory computer-readable medium of claim 11, further comprising instructions for:
receiving input from a user in a web editor to designate an X coordinate and Y coordinate of the design image on the base image;
using the X coordinate and Y coordinate to determine a correspondence between pixels of the design image and the mask image.

14. The non-transitory computer-readable medium of claim 11, further comprising instructions for:
applying the mask image to the design image as a mask so that pixels of the design image outside of the mask are not shown and pixels of the design image inside the mask are shown.

15. The non-transitory computer-readable medium of claim 11, further comprising instructions for:
multiplying the luminance values by the corresponding pixels of the design image.

16. The non-transitory computer-readable medium of claim 11, further comprising instructions for:
multiplying the luminance values by the corresponding pixels of the design image and adding the corresponding pixels of the base image.

17. The non-transitory computer-readable medium of claim 11, further comprising instructions for:
multiplying the luminance values by the corresponding pixels of the design image and adding the corresponding pixels of the base image.

18. The non-transitory computer-readable medium of claim 11, further comprising instructions for:
providing a highlight image representing the properties of a material of interest;
positioning the highlight image on top of the final image, where the final image is at least partly visible through the highlight image.

19. The non-transitory computer-readable medium of claim 18, wherein the highlight image is translucent.

20. The non-transitory computer-readable medium of claim 18, further comprising instructions for:
alpha-blending chrominance information of the highlight image with the final image.
